(19) United States
(12) Patent Application Publication
(10) Pub. No.: US 2025/0245554 A1
(43) Pub. Date: Jul. 31, 2025

(54) SYSTEM FOR QUALITY CONTROL OF DATA BY DOUBLE BLINDED VERIFICATION AND A METHOD THEREOF

(71) Applicant: Brightleaf Solutions, Inc., Brookline, MA (US)

(72) Inventor: Samir Bhatia, Brookline, MA (US)

(21) Appl. No.: 18/426,510

(22) Filed: Jan. 30, 2024

(51) Int. Cl. G06N 20/00

(52) U.S. Cl. CPC G06N 20/00

(57) ABSTRACT

A system to perform quality control of data by double blinded verification is disclosed. The system includes a processing subsystem which includes a data extraction module for parsing one or more documents to extract a plurality of data points by using machine learning model to generate a first transaction and a plurality of sub-transactions, a verification module verifies each of the plurality of sub-transactions individually by a first user and a second user respectively, a comparison module compares the verified results of the plurality of sub-transactions to identify a plurality of differences and filters and marks the plurality of differences in the verified results, a quality check module generates a second transaction by using the machine learning model, assigns the second transaction with the marked differences to a third user for a subsequent review, and updates the plurality of datapoints in response to the review made by a third user.

### FIELD OF INVENTION

Embodiments of a present disclosure relate to the field of data processing and more particularly to a system for quality control of data by double blinded verification and a method thereof.

### BACKGROUND

Quality control (QC) of data refers to multiple applications of methods or processes that determine whether the data meets an overall quality goal(s) and defined quality criteria for individual values. Further, quality control is vital to maintain the integrity and viability of data. Several types of systems and methods are used to monitor data so that may spot issues before they spiral out of control. The quality control of data includes data analysis, data verification, and the like. There are different data verification techniques such as manual data verification, automatic data verifications, sampling data verification, and so on. Further, data verification also includes taking sample data from both the source and destination systems to manually verify data accuracy.

Currently, automated technology such as machine learning (ML) and artificial intelligence (AI) techniques are used for quality control of data. However, such data with automated technology have additional technical problems. For instance, the amount of available data is too limited to train an algorithm of AI and ML. The AI and ML usually requires millions of data points, because a large amount of data such as legal data is not publicly available due to confidentiality requirements. Further, the currently used technologies and methods does not efficiently and accurately conduct verification of data. The existing methods and systems need excess time and expense while conducting the quality control such as time required during a document review, a data verification, and the like.

Hence, there is a need a system for quality control of data by double blinded verification and a method thereof which addresses the aforementioned issues.

### OBJECTIVE OF THE INVENTION

An objective of the present invention is to obtain differences of quality control for the same data from two different users. This is herein referred as ‘double blinded verification’.

Another objective of the present invention is to verify the differences from the two different users with a third user thereby enabling quality check at multiple levels for the same data.

### BRIEF DESCRIPTION

In accordance with one embodiment of the disclosure a computer-implemented system to perform quality control of data by double blinded verification is provided. The system includes a processing subsystem hosted on a server and configured to execute on a network to control bidirectional communications among a plurality of modules. The plurality of modules includes a data extraction module, a verification module, a comparison module, and a quality check module. The data extraction module is configured to parse one or more documents to extract a plurality of data points by using machine learning model to generate a first transaction wherein the one or more documents includes unstructured data. The data extraction module is also configured to generate a plurality of sub-transactions from the first transaction wherein each of the plurality of sub-transactions comprises the plurality of data points. The verification module is operatively coupled to the data extraction module, the verification module is configured to verify each of the plurality of sub-transactions individually by a first user and a second user respectively thereby resulting in a first level of verification. The comparison module is operatively coupled to the verification module. The comparison module is configured to compare the verified results of the plurality of sub-transactions to identify a plurality of differences. The comparison module is also configured to filter and mark the plurality of differences in the verified results. The quality check module is operatively coupled to the comparison module. The quality check module is configured to generate a second transaction by using the machine learning model. The second transaction is based on the marked differences of the verified results. The quality check module is also configured to assign the second transaction with the marked differences to a third user for a subsequent review thereby resulting in a second verification level. Further, the quality check module is configured to update the plurality of datapoints in response to the review made by a third user thereby enabling quality check of the one or more documents over multiple levels of verification.

In accordance with another embodiment, a computer-implemented method for performing double blinded verification of data is provided. The method includes parsing, by a data extraction module of a processing subsystem, one or more documents to extract a plurality of data points by using machine learning model for generating a first transaction wherein the one or more documents includes unstructured data. The method also includes generating, by the data extraction module of the processing subsystem, a plurality of sub-transactions from the first transaction wherein each of the plurality of sub-transactions comprises the plurality of data points. Further, the method includes verifying, by a verification module of the processing subsystem, each of the plurality of sub-transactions individually by a first user and a second user respectively thereby resulting in a first level of verification. Furthermore, the method includes comparing, by a comparison module of the processing subsystem, the verified results of the plurality of sub-transactions for identifying a plurality of differences. Furthermore, the method includes filtering and marking, by the comparison module of the processing subsystem the plurality of differences in the verified results. Furthermore, the method includes generating, by a quality check module of the processing subsystem, a second transaction by using the machine learning model wherein the second transaction is based on the marked differences of the verified results. Furthermore, the method includes assigning, by the quality check module of the processing subsystem, the second transaction with the marked differences to a third user for a subsequent review thereby resulting in a second verification level. Furthermore, the method includes updating, by the quality check module of the processing subsystem, the plurality of datapoints in response to the review made by a third user thereby enabling quality check of the one or more documents over multiple levels of verification.

In accordance with an embodiment of the present disclosure a non-transitory computer-readable medium storing a computer program that, when executed by a processor, causes the processor to perform a method for performing double blinded verification of data is provided. The method includes parsing, by a data extraction module of a processing subsystem, one or more documents to extract a plurality of data points by using machine learning model for generating a first transaction wherein the one or more documents includes unstructured data. The method also includes generating, by the data extraction module of the processing subsystem, a plurality of sub-transactions from the first transaction wherein each of the plurality of sub-transactions comprises the plurality of data points. Further, the method includes verifying, by a verification module of the processing subsystem, each of the plurality of sub-transactions individually by a first user and a second user respectively thereby resulting in a first level of verification. Furthermore, the method includes comparing, by a comparison module of the processing subsystem, the verified results of the plurality of sub-transactions for identifying a plurality of differences. Furthermore, the method includes filtering and marking, by the comparison module of the processing subsystem the plurality of differences in the verified results. Furthermore, the method includes generating, by a quality check module of the processing subsystem, a second transaction by using the machine learning model wherein the second transaction is based on the marked differences of the verified results. Furthermore, the method includes assigning, by the quality check module of the processing subsystem, the second transaction with the marked differences to a third user for a subsequent review thereby resulting in a second verification level. Furthermore, the method includes updating, by the quality check module of the processing subsystem, the plurality of datapoints in response to the review made by a third user thereby enabling quality check of the one or more documents over multiple levels of verification.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representing a computer-implemented system for quality control of data by double blinded verification in accordance with an embodiment of the present disclosure;

FIG. 2 is a block diagram an exemplary embodiment for the computer-implemented system for quality control of data by double blinded verification of FIG. 1 in accordance with an embodiment of the present disclosure;

FIG. 3 is a flow chart representing a workflow for quality control of data by double blinded verification of FIG. 1 in accordance with an embodiment of the present disclosure;

FIG. 4 is a block diagram of a computer or a server for a system for quality control of data by double blinded verification in accordance with an embodiment of the present disclosure; and

FIG. 5 is a flow chart representing steps involved in of a computer-implemented method for performing double blinded verification of data in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures, or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

In the discussion that follows, references are made to a ‘first user’, ‘second user’ and a ‘third user’ with respect to users who verify a plurality of documents across multiple levels. Specifically, the ‘first user’ and the ‘second user’ verifies the plurality of documents at a first level and the ‘third user’ verifies the said plurality of documents at a second level respectively. Further, the ‘first user’, ‘second user’ and the ‘third user’ belong to a single organisation or company.

Embodiments of the present disclosure relate to a computer-implemented system to perform quality control of data by double blinded verification is provided. The system includes a processing subsystem hosted on a server and configured to execute on a network to control bidirectional communications among a plurality of modules. The plurality of modules includes a data extraction module, a verification module, a comparison module, and a quality check module. The data extraction module is configured to parse one or more documents to extract a plurality of data points by using machine learning model to generate a first transaction wherein the one or more documents includes unstructured data. The data extraction module is also configured to generate a plurality of sub-transactions from the first transaction wherein each of the plurality of sub-transactions comprises the plurality of data points. The verification module is operatively coupled to the data extraction module, the verification module is configured to verify each of the plurality of sub-transactions individually by a first user and a second user respectively thereby resulting in a first level of verification. The comparison module is operatively coupled to the verification module. The comparison module is configured to compare the verified results of the plurality of sub-transactions to identify a plurality of differences. The comparison module is also configured to filter and mark the plurality of differences in the verified results. The quality check module is operatively coupled to the comparison module. The quality check module is configured to generate a second transaction by using the machine learning model. The second transaction is based on the marked differences of the verified results. The quality check module is also configured to assign the second transaction with the marked differences to a third user for a subsequent review thereby resulting in a second verification level. Further, the quality check module is configured to update the plurality of datapoints in response to the review made by a third user thereby enabling quality check of the one or more documents over multiple levels of verification.

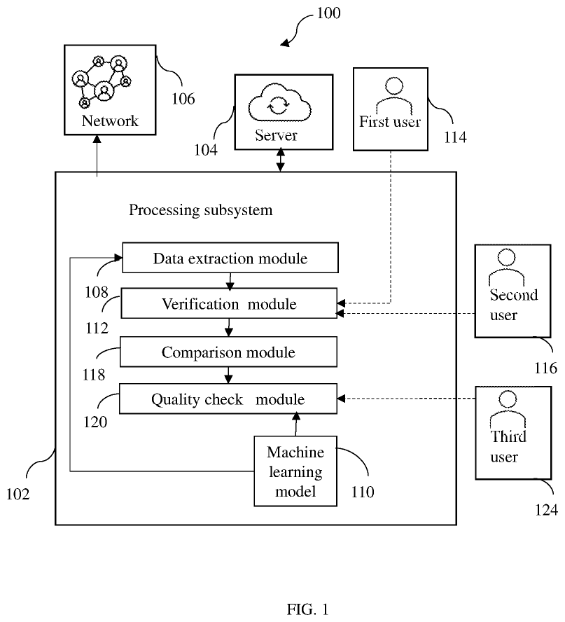

FIG. 1 is a block diagram representing a computer-implemented system for performing quality control of data by double blinded verification in accordance with an embodiment of the present disclosure. The system 100 includes a processing subsystem 102, is hosted on a server 104 configured to execute on a network 106 to control bidirectional communications among a plurality of modules. In one embodiment, the server 104 may include a cloud server. In another embodiment, the server 104 may include a local server. In one embodiment, the network 106 may include a wired network such as a local area network (LAN). In another embodiment, the network may include a wireless network such as Wi-Fi, Bluetooth, Zigbee, near-field communication (NFC), infrared communication (RFID), or the like.

Further, in another embodiment, the network 106 may include both wired and wireless communications according to one or more standards and/or via one or more transport mediums. Furthermore, in one example, the network 106 may include wireless communications according to one of the 802.11 or Bluetooth specification sets, or another standard or proprietary wireless communication protocol. In yet another embodiment, the network 106 may also include communications over a terrestrial cellular network, including, a GSM (global system for mobile communications), CDMA (code division multiple access), and/or EDGE (enhanced data for global evolution) network.

The plurality of modules includes a data extraction module 108, a verification module 112, a comparison module 118, and a quality check module 120.

The data extraction module 108 is configured to parse one or more documents to extract a plurality of data points by using a machine learning model 110 to generate a first transaction. As used herein “parse or parsing” is a method to analyze a plurality of sentences (from the one or more documents) to identify and extract its corresponding structural components (for instance, entities, relationships between the entities and context). The structural components are herein referred to as ‘data points.’ Typically, parsing is performed by the machine learning model 110 using Natural Language Processing (NLP). The NLP is a field of artificial intelligence (AI) that focuses on interactions between computers and humans through natural language.

It must be noted that the one or more documents includes unstructured data. In one embodiment, the data extraction module 108 may receive the one or more documents from a user. In one embodiment, the document may be a file extension defined as a suffix attached to a filename, separated by a period, which indicates type of a file. In one embodiment, the predefined file extension may include at least one of a portable document format, and office open extensible markup language. In some embodiments, the one or more documents may include a text file, the portable document file, and the like. Examples of the one or more documents includes, but is not limited to, health related data, legal documents, comic data, personal data and demographic data. It must be noted that the first instance of parsing is herein referred to as ‘first transaction’. Typically, the first transaction is performed by a first user and a second user.

Additionally, the data extraction module 108 is configured to generate a plurality of sub-transactions from the first transaction. Each of the plurality of sub-transactions includes the plurality of data points. It must be noted that the said plurality of data points are the same that were extracted in the first transaction. The machine learning model 110 is a model with process which can find patterns or make decisions from a previously unseen data. The datapoint extraction generates a plurality of sub-transactions from the first transaction. In one embodiment, the transaction access data using read and write operations and the sub-transactions are started when the first transaction is already active.

Considering a non-limiting example, where a user X inputs a legal document by using a user interface, which is then parsed by the data extraction module 108. After parsing the document, the plurality of datapoints are extracted by using the machine learning model 110 by using a pre-defined data extraction application. The machine learning model 110 is trained for extraction of specific datapoints by using predefined rules. In such an embodiment, the training of the machine learning model 110 is performed by using the data (prior to extraction) over time. In such an embodiment, training of machine learning model 110 (ML) may be described as follows. Initially, the plurality of datapoints from a document is collected and processed for a specific attribute. The verification of data-and computation-is applicable for ML applications. Advancements in ML have offered many opportunities to accelerate verification workflow, improve verification quality, and automate verification execution. However, being a data-centric method, ML has also elevated data to become the most crucial factor of ML success. Further a training data set may be created in a form of a list including the data points and class of respective attribute in the document. The training data set may be used to train the pretrained language model.

The verification module 112 is operatively coupled to the data extraction module 108 wherein the verification module 112 is configured to verify each of the plurality of sub-transactions individually by a first user 114 and a second user 116 respectively thereby resulting in a first level of verification. Typically, the extracted data points undergoes quality check by the verification module 112. It must be noted that the first user 114 and the second user 116 verifies the same extracted data points. As used herein, the machine learning (ML) model is a field of artificial intelligence (AI). The machine learning model 110 is a model with process which can find patterns or make decisions from a previously unseen data.

Additionally, in one embodiment, if the first user 114 and the second user 116 are unsure about the verification of a specific said extracted data points then, the first user 114 and the second user 116 may flag the said extracted data points as ‘doubtful’. In such an embodiment, a third user 124 may cautiously verify the ‘doubtful’ extracted data points.

In one embodiment, the first user 114 and the second user 116 verifies the plurality of sub transactions at their individual level, which means the first user and the second user are unaware of each other while verifying the document. In continuation with the example stated in paragraph [0027], the legal document verified by using the double blinded method is a secure way of verification, as the legal document may contain confidential information.

The comparison module 118 is operatively coupled to the verification module 112. The comparison module 118 is configured to compare the verified results of the plurality of sub-transactions to identify a plurality of differences. The comparison module 118 is also configured to filter and mark the plurality of differences in the verified results made by the first user 114 and the second user 116. In one embodiment, the plurality of differences is the differences in the attributes of the data points. In one embodiment, the plurality of sub-transactions are generated for the legal document for further processing (as in paragraph [0030]). The result of the verified legal document is compared with multiple sub-transactions for finding any error if any in the legal document.

The quality check module 120 is operatively coupled to the comparison module 118. The quality check module 120 is configured to generate a second transaction by using the machine learning model 110. The second transaction is based on the marked differences of the verified results. The quality check module 120 is configured to assign the second transaction with the marked differences to a third user 124 for a subsequent review thereby resulting in a second verification level. Further, the quality check module 120 is configured to update the plurality of datapoints in response to the review made by the third user 124 thereby enabling quality check of the one or more documents over multiple levels of verification.

In one embodiment, the marked differences are reviewed in the second verification level by using a user interface. In one embodiment, the user interface may be associated with a user device including a computer, a personal digital assistant, laptop, and the like. In continuation with the example of the legal document consider a scenario in which, a first user may want a quality check for the effective date and the address of a second user extracted at a plurality of quality checking levels. In one embodiment, the user may be allowed for deciding number of verification levels. In one embodiment, the quality check module 120 is also configured to mark or assign a tag to each of the plurality of attributes of the plurality of datapoints in the first level of verification based on the first user 114 response. The one more tags are assigned to verified, and doubtful data attribute. Consider a scenario in which the data extracted is a data of submission of a document. At first level of verification, if the first user 114 may feel that the extracted date of document submission is correct then a comparison is performed. The comparison is performed to find the difference between the extracted date with the date present in the legal document. If there is no difference, then the quality check module 120 may tag the date extracted as verified based on the response provided by the first user 114. If there is difference between the extracted date and the date present in the document, then the date is marked as an error.

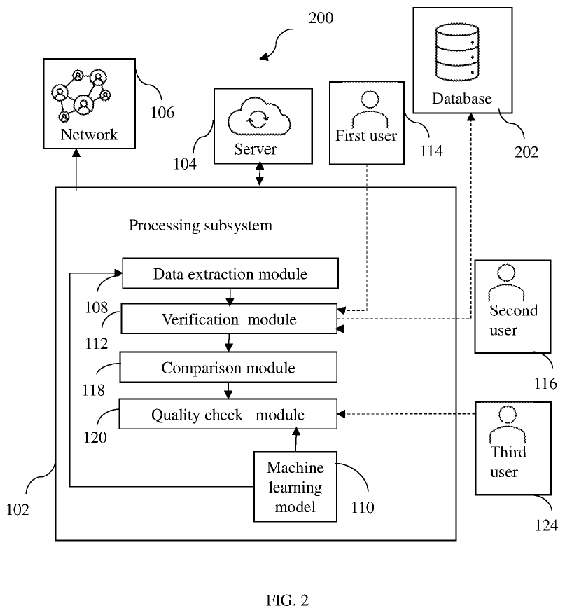

FIG. 2 is a block diagram an exemplary embodiment for the system for quality control of data by double blinded verification of FIG. 1 in accordance with an embodiment of the present disclosure. The processing subsystem includes a data extraction module 108, a verification module 112, a comparison module 118, and a quality check module 120. In one embodiment, the first user 114, the second user 116 and the third user 124 are ignorant of each other identity thereby enabling the double blinded verification of data. In one embodiment, the plurality of sub-transactions are merged to generate the second transaction upon verification of the plurality of sub-transactions.

In one embodiment, the verification module 112 is configured to enable the first user 114 and the second user 116 to tag an uncertain data at the time of verification to enable the third user 124 to validate the tagged uncertain data. If the verification module 112 finds no differences in the plurality of sub-transactions, an output of the first verification is considered as a final output. In one embodiment, the third user 124 is allowed to view the extracted, verified, or updated data at the first level of verification and the second level of verification.

In one embodiment, the data points may include a plurality of attributes such as dates, numbers, long text, short text, currencies, and percentages. In another embodiment, the data points are customized by using a plurality of keywords and forms based on the search requirements of the user. In one embodiment, the system 100 includes a database 202 to store the verified results along with the corresponding differences. In one embodiment, the database 202 may include a structured query language database. In some embodiments, the database 202 may include a non-structured query language database. In a specific embodiment, the database 202 may include a columnar database and the like.

Considering a non-limiting example, where a user Y inputs a legal document by using the user interface, which is then parsed by the data extraction module 108. After parsing the document, the plurality of datapoints are extracted by using the machine learning model 110 by using a pre-defined data extraction application. The data extraction module 108 then extract data points based on data attributes such as address of the applicant of the legal document by generating multiple sub transactions. The extracted data is verified at first level of verification. In the first level of verification, the first user 114 and the second user 116 carry the verification individually. After first verification level, the verified data is compared with the predefined sub transactions to obtain the differences if any. ID there are no differences then the output of the first verification level is considered as final output. If there are differences, then the differences are filtered for marking. In one embodiment, the differences may be marked by using any a color-coded format. The marked differences are sent to the third user 124 for the second level of verification. The third user 124 individually perform the second level of verification. The result of the second verification level is updated by the quality check module 120 thereby enabling quality check of the one or more documents over multiple levels of verification.

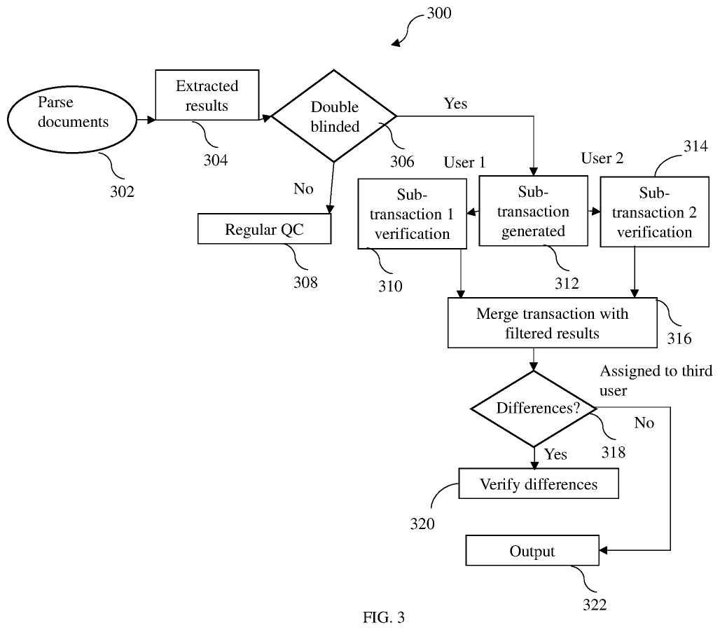

FIG. 3 is a flow chart representing a workflow the computer-implemented system for quality control of data by double blinded verification of FIG. 1 in accordance with an embodiment of the present disclosure. The workflow starts with the parsing of documents 302 by the system and extracting the results 304 and thereby generating a transaction. After extraction if the double blinded option is not enabled then a quality control 308 is performed on the extracted data without double blinded method (in other words, a regular quality check is performed). If the double blinded 306 option is enabled, then by using an extraction application, two sub transactions are generated 312 and assigned to two distinct users. The two sub transactions are a sub-transaction 1 verification 310 and a sub-transaction 2 verification 314 The assigned sub-transactions are verified by both the users independently. Upon completion of verification of sub transactions by both the users (user 1 and user 2) individually. The sub transactions are merged upon filtering the corresponding results 316. The extraction application proceeds to compare the results of verification of these sub transactions. Subsequently, a new transaction is generated by the system. The generated new transaction is highlighted to find the differences 318. At the occurrence of differences then, the said differences are verified 320. The assigned differences are highlighted for further reference and review. If there are no differences, then the result of the first verification level is assigned to the third user 124 and the results are considered as final output 322. In one embodiment, at any verification level the user can view the extracted results and values verified or updated at the previous verification level.

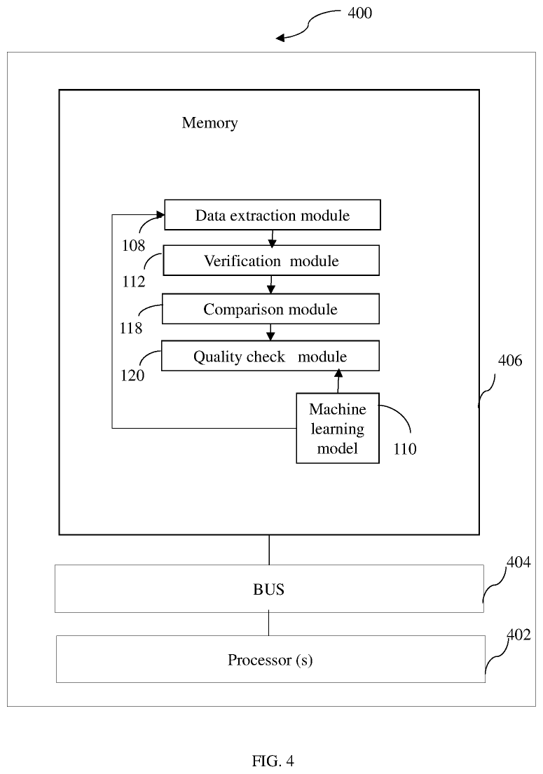

FIG. 4 is a block diagram of a computer or a server for a system for performing quality control of data by double blinded verification in accordance with an embodiment of the present disclosure in accordance with an embodiment of the present disclosure. The server includes a processor(s) 402, and memory 406 operatively coupled to the bus 404.

The processor(s) 402, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The bus 404 as used herein refers to be internal memory channels or computer network that is used to connect computer components and transfer data between them. The bus 404 includes a serial bus or a parallel bus, wherein the serial bus transmits data in a bit-serial format and the parallel bus transmits data across multiple wires. The bus 404 as used herein, may include but not limited to, a system bus, an internal bus, an external bus, an expansion bus, a frontside bus, a backside bus, and the like.

The memory 406 includes a plurality of subsystems and a plurality of modules stored in the form of an executable program which instructs the processor to the system illustrated in FIG. 1. The memory 406 is substantially similar for providing the system liquidation of illiquid assets of FIG. 1. The memory 406 has submodules: a data extraction module 108, a verification module 112, a comparison module 118, and a quality check module 120.

The data extraction module 108 is configured to parse one or more documents to extract a plurality of data points by using machine learning model 110 to generate a first transaction. The one or more documents includes unstructured data. The data extraction module 108 is also configured to generate a plurality of sub-transactions from the first transaction. Each of the plurality of sub-transactions includes the plurality of data points. In one embodiment, the data extraction module 108 may receive the one or more documents from a user. In one embodiment, the document may be a file extension defined as a suffix attached to a filename, separated by a period, which indicates type of a file.

The verification module 112 is operatively coupled to the data extraction module 108 wherein the verification module 112 is configured to verify each of the plurality of sub-transactions individually by a first user 114 and a second user 116 respectively thereby resulting in a first level of verification. As used herein, the machine learning (ML) model is a field of artificial intelligence (AI). The machine learning model 110 is a model with process which can find patterns or make decisions from a previously unseen data.

The comparison module 118 is operatively coupled to the verification module 112. The comparison module 118 is configured to compare the verified results of the plurality of sub-transactions to identify a plurality of differences. The comparison module 118 is also configured to filter and mark the plurality of differences in the verified results.

The quality check module 120 is operatively coupled to the comparison module 118. The quality check module 120 is configured to generate a second transaction by using the machine learning model 110. The second transaction is based on the marked differences of the verified results. The quality check module 120 is configured to assign the second transaction with the marked differences to a third user 124 for a subsequent review thereby resulting in a second verification level. Further, the quality check module 120 is configured to update the plurality of datapoints in response to the review made by the third user 124 thereby enabling quality check of the one or more documents over multiple levels of verification.

Computer memory elements may include any suitable memory device(s) for storing data and executable program, such as read-only memory, random access memory, erasable programmable read-only memory, electrically erasable programmable read-only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. An executable program stored on any of the above-mentioned storage media may be executable by the processor(s) 402.

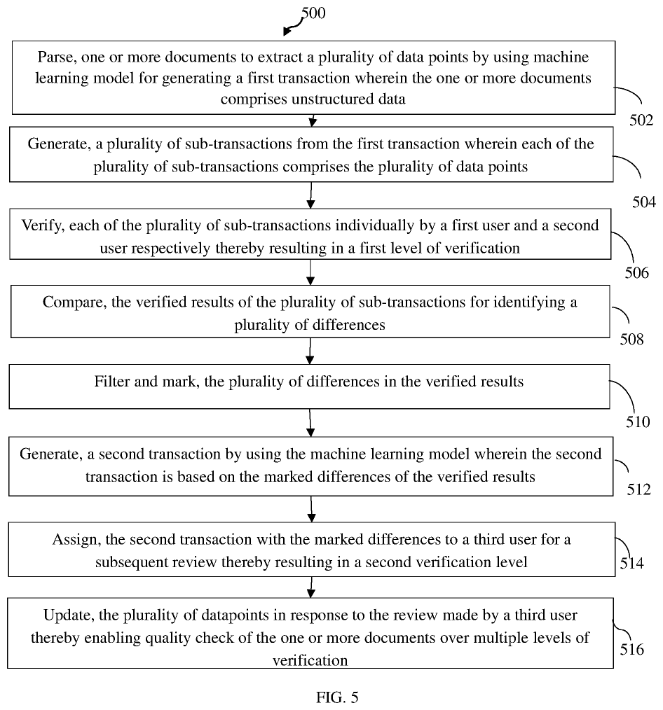

FIG. 5 is a flow chart representing steps involved in a computer-implemented method for performing double blinded verification of data in accordance with an embodiment of the present disclosure.

The method 500 includes parsing, by a data extraction module of a processing subsystem, one or more documents to extract a plurality of data points by using ser for generating a first transaction in step 502. In one embodiment, the data points includes dates, numbers, long text, short text, currencies, and percentages. The method also includes customizing, the data points by using a plurality of keywords and forms based on the search requirements of the user.

The method 500 also included generating, by the data extraction module of the processing subsystem, a plurality of sub-transactions from the first transaction wherein each of the plurality of sub-transactions comprises the plurality of data points in step 504. The method also includes merging, the plurality of sub-transactions to generate the second transaction upon verification of the said plurality of sub-transactions.

Further, the method 500 includes verifying, by a verification module of the processing subsystem, each of the plurality of sub-transactions individually by a first user and a second user respectively thereby resulting in a first level of verification in step 506. In one embodiment, the first user, the second user and the third user are ignorant of each other identity thereby enabling the double blinded verification of data.

The method 500 also includes tagging, by the first user and the second user, an uncertain data at the time of verification to enable the third user to validate the tagged uncertain data. The method also includes considering, an output of the first verification as a final output if the verification module finds no differences in the plurality of sub-transactions. The method 500 also includes tagging an uncertain data by the first user and the second user at the time of verification to enable the third user to validate the tagged uncertain data.

Furthermore, the method 500 includes comparing, by a comparison module of the processing subsystem, the verified results of the plurality of sub-transactions for identifying a plurality of differences in step 508.

Furthermore, the method 500 includes filtering and marking, by the comparison module of the processing subsystem the plurality of differences in the verified results in step 510.

Furthermore, the method 500 includes generating, by a quality check module of the processing subsystem, a second transaction by using the machine learning model wherein the second transaction is based on the marked differences of the verified results in step 512.

Furthermore, the method 500 includes assigning, by the quality check module of the processing subsystem, the second transaction with the marked differences to a third user for a subsequent review thereby resulting in a second verification level in step 514. The method 500 also includes allowing, the third user to view the extracted, verified, or updated data at the first level of verification and the second level of verification.

Furthermore, the method 500 includes updating, by the quality check module of the processing subsystem, the plurality of datapoints in response to the review made by a third user thereby enabling quality check of the one or more documents over multiple levels of verification in step 516.

In one embodiment, the method 500 also includes storing, the verified results along with the corresponding differences in a database. In one embodiment, the one or more documents includes unstructured data. The method 500 also includes highlighting the plurality of differences in colour coded format. The method 500 also includes viewing, the extracted datapoints and values of a plurality of attributes of the extracted datapoints, wherein the values are verified or updated at a previous verification level.

Various embodiments of the present disclosure provide a computer-implemented system for quality control of data by using a double blinded verification method. The data extraction module of the system disclosed in the present disclosure extracts a plurality of datapoints and values of attributes of the data points at a quality control verification level. At any verification level, the extracted datapoint are verified or updated at the previous verification level.

Also, the verification module of the system disclosed in the present disclosure facilitates verification of each of the plurality of sub-transactions generated by the data extraction module, by the first user and the second user individually at the first level of verification. Further, the comparison module of the system disclosed in the present disclosure facilitates comparison of the verified results and identifies a plurality of differences for marking them in the verified results. The marked differences are provided to the third user for second level of verification.

Furthermore, the quality check module of the system disclosed in the present disclosure uses the machine learning module to generate a second transaction which is assigned to the third user for further verification. The quality check module also facilitates updating the plurality of datapoints in response to the review made by the third user thereby enabling quality check of the one or more documents over multiple levels of verification.

Moreover, the present disclosure provides a system and a method to provide accurate extracted data.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and is not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A computer-implemented system to perform quality control of data by double blinded verification comprising:
a hardware processor; and
a memory coupled to the hardware processor, wherein the memory comprises a set of instructions in the form of a processing subsystem, configured to be executed by the hardware processor, wherein the processing subsystem is hosted on a server, and configured to execute on a network to control bidirectional communications among a plurality of modules wherein the plurality of modules comprises:
a data extraction module configured to:
parse one or more documents to extract a plurality of data points by using machine learning model to generate a first transaction; and
generate a plurality of sub-transactions from the first transaction wherein each of the plurality of sub-transactions comprises the plurality of data points;
a verification module operatively coupled to the data extraction module wherein the verification module is configured to verify each of the plurality of sub-transactions individually by a first user and a second user respectively thereby resulting in a first level of verification;
a comparison module operatively coupled to the verification module wherein the comparison module is configured to:
compare the verified results of the plurality of sub-transactions to identify a plurality of differences; and
filter and mark the plurality of differences in the verified results; and
a quality check module operatively coupled to the comparison module wherein the quality check module is configured to:
generate a second transaction by using the machine learning model wherein the second transaction is based on the marked differences of the verified results;
assign the second transaction with the marked differences to a third user for a subsequent review thereby resulting in a second verification level; and
update the plurality of datapoints in response to the review made by the third user thereby enabling quality check of the one or more documents over multiple levels of verification.

2. The computer-implemented system as claimed in claim 1, wherein the first user, the second user and the third user are ignorant of each other identity thereby enabling the double blinded verification of data.

3. The computer-implemented system as claimed in claim 1, wherein the plurality of sub-transactions are merged to generate the second transaction upon verification of the said plurality of sub-transactions.

4. The computer-implemented system as claimed in claim 1, wherein the verification module is configured to enable the first user and the second user to tag an uncertain data at the time of verification to enable the third user to validate the tagged uncertain data.

5. The computer-implemented system as claimed in claim 1, wherein the third user is allowed to view the extracted, verified, or updated data at the first level of verification and the second level of verification.

6. The computer-implemented system as claimed in claim 1, wherein the data points comprises dates, numbers, long text, short text, currencies, and percentages.

7. The computer-implemented system as claimed in claim 1, wherein the data points are customized by using a plurality of keywords and forms based on the search requirements of the user.

8. The computer-implemented system as claimed in claim 1, wherein if the verification module finds no differences in the plurality of sub-transactions, an output of the first verification is considered as a final output.

9. The computer-implemented system as claimed in claim 1, further comprising a database to store the verified results along with the corresponding differences.

10. The computer-implemented system as claimed in claim 1, wherein the one or more documents includes unstructured data.

11. The computer-implemented system as claimed in claim 1, wherein the plurality of differences are marked by highlighting the differences in colour coded format.

12. A computer-implemented method for performing double blinded verification of data comprising:
parsing, by a data extraction module of a processing subsystem, one or more documents to extract a plurality of data points by using machine learning model for generating a first transaction;
generating, by the data extraction module of the processing subsystem, a plurality of sub-transactions from the first transaction wherein each of the plurality of sub-transactions comprises the plurality of data points;
verifying, by a verification module of the processing subsystem, each of the plurality of sub-transactions individually by a first user and a second user respectively thereby resulting in a first level of verification;
comparing, by a comparison module of the processing subsystem, the verified results of the plurality of sub-transactions for identifying a plurality of differences;
filtering and marking, by the comparison module of the processing subsystem the plurality of differences in the verified results;
generating, by a quality check module of the processing subsystem, a second transaction by using the machine learning model wherein the second transaction is based on the marked differences of the verified results;
assigning, by the quality check module of the processing subsystem, the second transaction with the marked differences to a third user for a subsequent review thereby resulting in a second verification level; and
updating, by the quality check module of the processing subsystem, the plurality of datapoints in response to the review made by a third user thereby enabling quality check of the one or more documents over multiple levels of verification.

13. The computer-implemented method as claimed in claim 12, comprises tagging an uncertain data by the first user and the second user at the time of verification to enable the third user to validate the tagged uncertain data.

14. The computer-implemented method as claimed in claim 12, comprises viewing, the extracted datapoints and values of a plurality of attributes of the extracted datapoints, wherein the values are verified or updated at a previous verification level.

15. A non-transitory computer-readable medium storing a computer program that, when executed by a processor, causes the processor to perform a method for performing double blinded verification of data, wherein the method comprises:
parsing, by a data extraction module of a processing subsystem, one or more documents to extract a plurality of data points by using machine learning model for generating a first transaction wherein the one or more documents comprises unstructured data;
generating, by the data extraction module of the processing subsystem, a plurality of sub-transactions from the first transaction wherein each of the plurality of sub-transactions comprises the plurality of data points;
verifying, by a verification module of the processing subsystem, each of the plurality of sub-transactions individually by a first user and a second user respectively thereby resulting in a first level of verification;
comparing, by a comparison module of the processing subsystem, the verified results of the plurality of sub-transactions for identifying a plurality of differences;
filtering and marking, by the comparison module of the processing subsystem the plurality of differences in the verified results;
generating, by a quality check module of the processing subsystem, a second transaction by using the machine learning model wherein the second transaction is based on the marked differences of the verified results;
assigning, by the quality check module of the processing subsystem, the second transaction with the marked differences to a third user for a subsequent review thereby resulting in a second verification level; and
updating, by the quality check module of the processing subsystem, the plurality of datapoints in response to the review made by a third user thereby enabling quality check of the one or more documents over multiple levels of verification.
